(19) United States
(12) Patent Application Publication
(10) Pub. No.: US 2026/0307497 A1
(43) Pub. Date: Oct. 8, 2026

(54) TORQUE CONTROL METHOD AND SYSTEM FOR ALL-WHEEL DISTRIBUTED VEHICLE

(71) Applicant: Schaeffler Technologies AG & Co. KG, Herzogenaurach (DE)

(72) Inventor: Zhengtao Lv, Shanghai (CN)

(21) Appl. No.: 19/485,141

(22) PCT Filed: May 15, 2023
(86) PCT No.: PCT/CN2023/094182

§ 371 Date: Nov. 17, 2025

(51) Int. Cl. B60L 3/10; B60L 15/20

(52) U.S. Cl. CPC B60L 3/106; B60L 15/2036; B60L 2240/12; B60L 2240/423; B60L 2240/461; B60L 2240/463; B60L 2240/465

(57) ABSTRACT

A torque control method for an all-wheel distributed vehicle includes step S1, in response to a skidding state of a vehicle, acquiring adhesion coefficients of a reference wheel and other wheels; step S2, on the basis of the adhesion coefficients of the other wheels, acquiring a target drive torque for preventing the skidding of the reference wheel; step S3, in response to the reference wheel not skidding, acquiring a wheel linear speed of the reference wheel, and taking the wheel linear speed as a reference vehicle speed of the vehicle; and step S4, adjusting drive torques of the other wheels on the basis of the reference vehicle speed. A target drive torque for preventing the skidding of a reference wheel is obtained by means of adhesion coefficients of other wheels, and a wheel speed of the reference wheel is taken as a reference vehicle speed.

### CROSS-REFERENCE TO RELATED APPLICATION

The present application is the U.S. National Phase of PCT Patent Application Number PCT/CN2023/094182, filed on May 15, 2023, the entire disclosure of which is incorporated by reference herein.

### TECHNICAL FIELD

The present disclosure relates to the technical field of vehicle control, in particular to a torque control method and system for an all-wheel distributed vehicle.

### BACKGROUND ART

As shown in FIG. 1, an all-wheel distributed drive automobile is provided with four independent motors corresponding to four wheels, respectively. Therefore, the torques and speeds of the four wheels may be independently controlled. When the drive automobile is on a road having a low adhesion coefficient, an output torque of each motor may be controlled to control a torque of the corresponding wheel, thereby preventing wheel skidding and loss of a drive force.

Therefore, to prevent the wheel skidding and loss of a drive force, whether the output torques of the motors can be accurately controlled to maximize utilization of a road adhesive force is an urgent problem to be solved for an all-wheel distributed drive automobile.

### SUMMARY OF THE INVENTION

To overcome the problem existing in the related art, the present disclosure provides a torque control method and system for an all-wheel distributed vehicle.

According to a first aspect of embodiments of the present disclosure, the present disclosure provides a torque control method for an all-wheel distributed vehicle, including: step S1: in response to a skidding state of a vehicle, acquiring adhesion coefficients of a reference wheel and other wheels; step S2: on the basis of the adhesion coefficients of the other wheels, acquiring a target drive torque for preventing the skidding of the reference wheel; step S3: in response to the reference wheel not skidding, acquiring a wheel linear speed of the reference wheel, and taking the wheel linear speed as a reference vehicle speed of the vehicle; and step S4: adjusting drive torques of the other wheels on the basis of the reference vehicle speed.

In some embodiments, the step S2 further specifically includes: step S21: on the basis of the adhesion coefficients of the other wheels, acquiring a target adhesion rate of the reference wheel; step S22: acquiring a wheel load of the reference wheel; and step S23: on the basis of the target adhesion rate and the wheel load of the reference wheel, acquiring a target drive torque for preventing the skidding of the reference wheel.

In some embodiments, in the step S21, the target adhesion rate of the reference wheel is a difference between the minimum value of the adhesion coefficients of the other wheels and a calibration value.

In some embodiments, in the step S21, the target adhesion rate of the reference wheel is a difference between the adhesion coefficient of the wheel on the same side and a calibration value.

In some embodiments, adjusting drive torques of the other wheels on the basis of the reference vehicle speed includes: step S41: on the basis of the reference vehicle speed, acquiring actual slip rates of the other wheels; and step S42: in response to the differences between the actual slip rates of the other wheels and a target slip rate, adjusting the drive torques of the other wheels, respectively.

According to a second aspect of the embodiments of the present disclosure, the present disclosure provides a torque control system for an all-wheel distributed vehicle, including: an adhesion coefficient acquisition module, in response to a skidding state of a vehicle, acquiring adhesion coefficients of a reference wheel and other wheels; a drive torque acquisition module, on the basis of the adhesion coefficients of the other wheels, acquiring a target drive torque for preventing the skidding of the reference wheel; a reference vehicle speed acquisition module, in response to the reference wheel not skidding, acquiring a wheel linear speed of the reference wheel, and taking the wheel linear speed as a reference vehicle speed of the vehicle; and an adjustment module adjusting drive torques of the other wheels on the basis of the reference vehicle speed.

In some embodiments, the drive torque acquisition module further specifically includes: a first acquisition module, on the basis of the adhesion coefficients of the other wheels, acquiring a target adhesion rate of the reference wheel; a second acquisition module acquiring a wheel load of the reference wheel; and a third acquisition module, on the basis of the target adhesion rate and the wheel load of the reference wheel, acquiring a target drive torque for preventing the skidding of the reference wheel.

In some embodiments, in the first acquisition module, the target adhesion rate of the reference wheel is a difference between the minimum value of the adhesion coefficients of the other wheels and a calibration value.

In some embodiments, in the first acquisition module, the target adhesion rate of the reference wheel is a difference between the adhesion coefficient of the wheel on the same side and a calibration value.

In some embodiments, adjusting drive torques of the other wheels on the basis of the reference vehicle speed includes: a fourth acquisition module, on the basis of the reference vehicle speed, acquiring actual slip rates of the other wheels; and a first adjustment module, in response to the differences between the actual slip rates of the other wheels and a target slip rate, adjusting the drive torques of the other wheels, respectively.

The technical solution provided by the embodiments of the present disclosure may include the following beneficial effects: compared with a reference vehicle speed acquired by means of integrated acceleration, Kalman filtering, and the like, the present disclosure obtains a drive torque for preventing the skidding of a reference wheel through adhesion coefficients of the other wheels, and then uses the wheel linear speed of the reference wheel as the reference vehicle speed, so that a numerical value of the obtained reference vehicle speed is more accurate and has less error. In addition, compared with a method of periodically reducing the drive force of one wheel, the reference vehicle speed of the present disclosure does not require wasting too many drive forces of the wheels, and also avoids the risk of vehicle turning or rollover caused by a yaw torque generated by reducing the drive force of one wheel, so that the vehicle driving and vehicle speed are more stable.

### BRIEF DESCRIPTION OF THE DRAWINGS

The accompanying drawings, which are incorporated in and constitute a part of this specification, illustrate embodiments consistent with the present disclosure and serve to explain the principles of the present disclosure together with the specification.

FIG. 1 is a structural schematic diagram of a chassis structure of an all-wheel distributed vehicle;

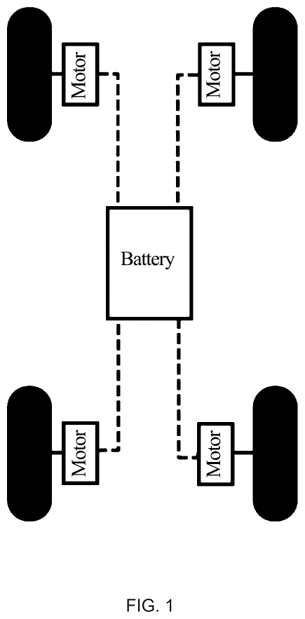

FIG. 2 is a schematic side view of an all-wheel distributed vehicle;

FIG. 3 is a schematic top view of an all-wheel distributed vehicle; and

FIG. 4 is a schematic flow chart of a torque control method for an all-wheel distributed vehicle illustrated according to an exemplary embodiment.

### DETAILED DESCRIPTION OF EMBODIMENTS

Embodiments will be described in detail herein, examples of which are illustrated in the accompanying drawings. When the drawings are referred to in the following description, the same numbers in different drawings refer to the same or similar elements unless otherwise indicated. The implementations described in the following exemplary embodiments do not represent all implementations consistent with the present disclosure. Rather, they are merely examples of apparatuses and methods consistent with some aspects of the present disclosure as detailed in the appended claims.

In the related art, the most important prerequisite for controlling a drive torque for preventing wheel skidding is to accurately learn the current reference vehicle speed (the longitudinal speed of actual driving of the center of mass of a vehicle relative to the ground). But if a driver presses an accelerator pedal hardly, all four wheels will output high drive torques, so all the four wheels may skid. This means that the wheel linear speed measured by a sensor in a skidding state cannot be used as a reference vehicle speed. Therefore, the reference vehicle speed can only be obtained by other methods, for example, an integrated acceleration method, a Kalman filtering method, or a method of periodically reducing the drive force of one of the wheels.

However, if the integrated acceleration method or Kalman filtering method is used to calculate the reference vehicle speed, a signal in the method comes from an acceleration sensor. An error of the acceleration sensor itself and a deviation caused by changes in road slope will inevitably be accumulated, resulting in a large numerical value error and inaccuracy in the calculated reference vehicle speed.

Furthermore, if the method of periodically reducing the drive force of one of the wheels is used, an additional yaw torque will be generated, thereby causing instability in vehicle driving and vehicle speed, potentially leading to the risk of vehicle turning or rolling over.

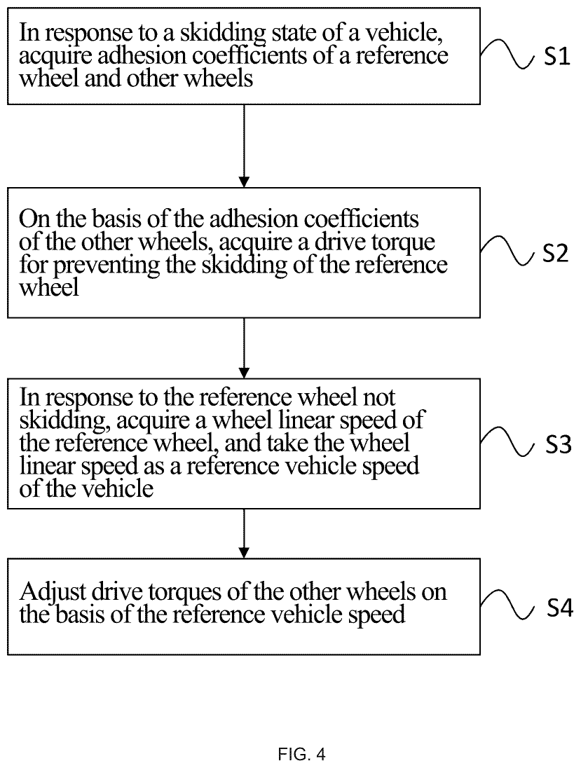

Therefore, to address the above technical problem, the present disclosure provides a torque control method for an all-wheel distributed vehicle, as shown in FIG. 4, including the following steps: step S1: in response to a skidding state of a vehicle, adhesion coefficients of a reference wheel and other wheels are acquired; step S2: on the basis of the adhesion coefficients of the other wheels, a target drive torque for preventing the skidding of the reference wheel is acquired; step S3: in response to the reference wheel not skidding, a wheel linear speed of the reference wheel is acquired, and the wheel linear speed is taken as a reference vehicle speed of the vehicle; and step S4: drive torques of the other wheels are adjusted on the basis of the reference vehicle speed.

The reference wheel is a preselected wheel, and the wheel linear speed of the wheel in a non-skidding state is used as a reference vehicle speed of the vehicle (i.e., vehicle speed). In this embodiment, a rear wheel may be selected as the reference wheel. When the rear wheels are stable and do not skid, the vehicle is driven more safely and stably.

In step S1, the vehicle acquires a real-time adhesion rate of each wheel, namely, the vehicle automatically monitors the adhesion rate of each wheel according to a cycle period, and the cycle period is typically a software running cycle, generally 1-10 ms. Whether there is skidding of a wheel may be determined by an acceleration of the wheel. When it is detected that the wheel does not skid, the adhesion coefficient is the maximum value of an adhesion rate calculated in the previous cycle and an adhesion rate calculated in the current cycle.

When it is detected that the wheel of a vehicle skids, the corresponding adhesion rate at the moment is the adhesion coefficient, wherein the adhesion rate is a ratio of a ground tangential reaction force caused by the drive torque acting on the wheel to a wheel normal reaction force (also called wheel load), namely, adhesion rate=wheel drive torque/wheel load. The adhesion coefficient is a ratio of the maximum limit value of the tangential reaction force of the ground to the wheel to the wheel normal reaction force, namely, the maximum value of the adhesion rate.

The adhesion rate of each wheel is obtained by acquiring the wheel load of each wheel and the drive torque of each wheel.

Signals required to acquire the wheel load include: longitudinal acceleration from a sensor, lateral acceleration from a sensor, road slope, and road inclination.

$$Front axle load GF = G * ( b / L * ( {g}^{2} - {slope}^{2} ) 0.5 / g - longitudinal acceleration * h / L / g ) ;$$

$$rear axle load GR = G * ( a / L * ( {g}^{2} - {slope}^{2} - {inclination}^{2} ) 0.5 / g - longitudinal acceleration * h / L / g ) ;$$

$$left front wheel load = GF * ( 0.5 - lateral acceleration * h / B / g ) ;$$

$$right front wheel load = GF * ( 0.5 + lateral acceleration * h / B / g ) ;$$

$$left rear wheel load = GR * ( 0.5 - lateral acceleration * h / B / g ) ; and$$

$$right rear wheel load GR * ( 0.5 + lateral acceleration * h / B / g ) .$$

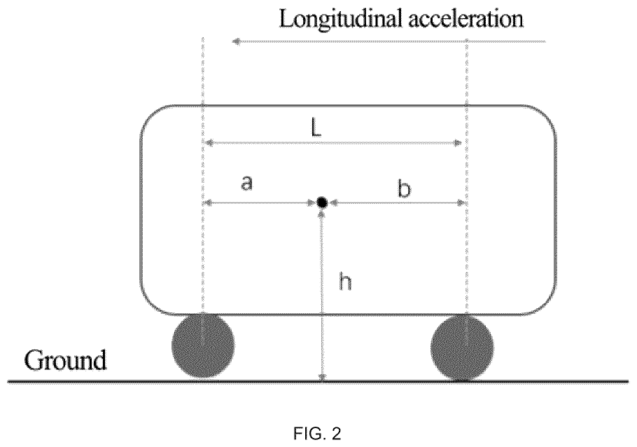

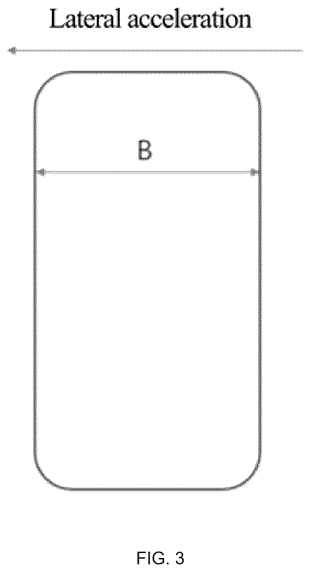

As shown in FIG. 2 and FIG. 3, G is the gravity of the vehicle, h is the height of the center of mass of the vehicle, L is a distance between a front axle and a rear axle, a is a distance between the front axle and the center of mass, b is a distance between the rear axle and the center of mass, B is the width of the axles, and g is the gravitational constant.

Signals required to obtain the drive torque of each wheel include: an output torque of a motor corresponding to each wheel from a sensor, and a wheel angular acceleration of each wheel from a sensor.

$$Wheel drive torque = ( output torque of the motor - ( wheel angular acceleration ) * J ) / R ,$$

where J is the moment of inertia, including the motor, the wheel, and a transmission component, and R is the wheel radius.

$$Finally , the adhesion rate of each wheel is obtained by adhesion rate = wheel drive torque / wheel load .$$

In some embodiments, step S2 further specifically includes: step S21: on the basis of the adhesion coefficients of the other wheels, acquiring a target adhesion rate of the reference wheel; step S22: acquiring a wheel load of the reference wheel; and step S23: on the basis of the target adhesion rate and the wheel load of the reference wheel, acquiring a target drive torque for preventing the skidding of the reference wheel.

Specifically, in some embodiments, in step S21, the target adhesion rate of the reference wheel is a difference between the minimum value of the adhesion coefficients (μ1, μ2, μ3) of the other wheels and a calibration value. Namely, target adhesion rate of the reference wheel=min(μ1, μ2, μ3)−calibration value, where the calibration value may be in a range of 0.02-0.05. In this way, the target adhesion rate of the reference wheel obtained is only slightly lower than adhesion rates of the other three wheels, without wasting too more drive torques of the motor.

In some other embodiments, in step S21, the target adhesion rate of the reference wheel is a difference between an adhesion coefficient of a wheel on the same side and a calibration value. For example, when the left rear wheel is the reference wheel, the target adhesion rate of the reference wheel may be a difference between an adhesion coefficient of the left front wheel and the calibration value. This may also reduce the calculated quantity of a system.

Furthermore, the wheel load of the reference wheel in step S22 has been described in detail in the aforementioned step of acquiring the wheel load, and will not be repeated here.

In step S23, with the target adhesion rate of the reference wheel obtained in step S21 and the wheel load of the reference wheel obtained in step S22, the target drive torque of the wheel is obtained by using the above formula: adhesion rate=wheel drive torque/wheel load.

According to the above formula: wheel drive torque=(output torque of the motor−(wheel angular acceleration)*J)/R, an output torque of the motor corresponding to the reference wheel is obtained, and the output torque of the motor is the maximum torque for preventing the skidding of the reference wheel.

Furthermore, in step S3, the output of the corresponding motor is controlled on the basis of the obtained output torque of the motor of the reference wheel, so that the reference wheel does not skid at the drive torque. In response to the reference wheel not skidding, a wheel linear speed of the reference wheel is acquired by a sensor, and the wheel linear speed is taken as a reference vehicle speed of the vehicle, namely, the wheel linear speed of the reference wheel is taken as the vehicle speed.

Thus, as can be seen from step S21, as long as the target adhesion rate of the reference wheel is only slightly lower than the minimum value of the adhesion coefficients of the other three wheels, or only slightly lower than the adhesion coefficient of the wheel on the same side, an accurate reference vehicle speed can be obtained, the loss of the drive torque of the motor of the reference wheel is minimal, and an additional yaw moment generated is also very small, so that the vehicle speed is more stable without threatening the driving stability and safety of the vehicle.

Furthermore, adjusting drive torques of the other wheels on the basis of the reference vehicle speed includes: step S41: on the basis of the reference vehicle speed, actual slip rates of the other wheels are acquired; and step S42: in response to the differences between the actual slip rates of the other wheels and a target slip rate, the drive torques of the other wheels are adjusted, respectively.

Specifically, the wheel slip rate (also known as the slip rate) is the proportion of a slip component in the wheel's motion.

The wheel linear speed of each wheel may be measured by a sensor. The vehicle speed is the reference vehicle speed in the non-skidding state of the reference wheel obtained in step S3. By the formula: wheel slip rate (wheel slip)=(wheel linear speed−vehicle speed)/wheel linear speed, the actual slip rates of the other three wheels at the reference vehicle speed may be obtained. The output torques of the motor of the other three wheels (or the drive torques of the wheels) are adjusted to adjust the wheel linear speed of each wheel until the actual slip rates of the other three wheels fall within a preset required range or are close to a target slip rate corresponding to each wheel and the vehicle no longer skids.

Each wheel has a target slip rate pre-calibrated on the basis of the vehicle and tire characteristics. The target slip rate is not a fixed numerical value, but under multiple input conditions such as different vehicle speeds and drive torques, the system may automatically generate a corresponding target slip rate.

In conclusion, compared with the reference vehicle speed acquired by means of integrated acceleration, Kalman filtering, and the like, the present disclosure obtains the drive torque for preventing the skidding of the reference wheel through adhesion coefficients of the other wheels, and then uses the wheel linear speed of the reference wheel as the reference vehicle speed, so that the numerical value of the obtained reference vehicle speed is more accurate and has less error.

In addition, compared with a method of periodically reducing the drive force of one of the wheels, the reference vehicle speed of the present disclosure does not require wasting too many drive forces of the wheels, and also avoids the risk of vehicle turning or rollover caused by a yaw torque generated by reducing the drive force of one wheel, so that the vehicle driving and vehicle speed are more stable.

On the basis of the same inventive concept, the present disclosure provides a torque control system for an all-wheel distributed vehicle, including: an adhesion coefficient acquisition module, in response to a skidding state of a vehicle, acquiring adhesion coefficients of a reference wheel and other wheels; a drive torque acquisition module, on the basis of the adhesion coefficients of the other wheels, acquiring a target drive torque for preventing the skidding of the reference wheel; a reference vehicle speed acquisition module, in response to the reference wheel non skidding, acquiring a wheel linear speed of the reference wheel, and taking the wheel linear speed as a reference vehicle speed of the vehicle; and an adjustment module adjusting drive torques of the other wheels on the basis of the reference vehicle speed.

In some embodiments, the drive torque acquisition module further specifically includes: a first acquisition module, on the basis of the adhesion coefficients of the other wheels, acquiring a target adhesion rate of the reference wheel; a second acquisition module acquiring a wheel load of the reference wheel; and a third acquisition module, on the basis of the target adhesion rate and the wheel load of the reference wheel, acquiring a target drive torque for preventing the skidding of the reference wheel.

In some embodiments, in the first acquisition module, the target adhesion rate of the reference wheel is a difference between the minimum value of the adhesion coefficients of the other wheels and a calibration value.

In some embodiments, in the first acquisition module, the target adhesion rate of the reference wheel is a difference between the adhesion coefficient of the wheel on the same side and a calibration value.

In some embodiments, adjusting drive torques of the other wheels on the basis of the reference vehicle speed includes: a fourth acquisition module, on the basis of the reference vehicle speed, acquiring actual slip rates of the other wheels; and a first adjustment module, in response to the differences between the actual slip rates of the other wheels and a target slip rate, adjusting the drive torques of the other wheels respectively.

Specific implementation of the torque control system for an all-wheel distributed vehicle in the above embodiments has been described in detail in the embodiments of the torque control method for an all-wheel distributed vehicle, and detailed descriptions thereof are omitted herein.

It can be understood that in the present disclosure, “a plurality of” refers to two or more, and other quantifiers are similar thereto. “And/or” describes the relationship between associated objects, indicating that three possible relationships exist. For example, “A and/or B” can mean: A exists alone, A and B exist simultaneously, or B exists alone. The character “/” generally indicates that the associated objects are in an “or” relationship. The singular forms “a”, “an”, and “the” are intended to include the plural forms as well, unless the context clearly indicates otherwise.

It can be further understood that the terms “first”, “second”, and the like are used to describe various structures, but these structures should not be limited to these terms. These terms are used solely to distinguish structures of the same type from one another and do not indicate a particular order or importance. In fact, the terms “first”, “second”, and the like are fully interchangeable. For example, a first structure may be referred to as a second structure, and similarly, a second structure may be referred to as a first structure, without departing from the scope of the present disclosure.

It can be further understood that orientations or position relationships indicated by the terms “center”, “longitudinal”, “lateral”, “front”, “back”, “upper”, “lower”, “left”, “right”, “vertical”, “horizontal”, “top”, “bottom”, “inner”, “outer”, and the like are on the basis of the orientations or position relationships shown in the accompanying drawings and are intended solely to facilitate description of the embodiments and simplify the description, rather than indicating or implying that apparatuses or elements referred to must have a particular orientation or be constructed and operated in a particular orientation.

It can be further understood that, unless otherwise specified, “connection” includes both direct connection without any other components between two elements and indirect connection with other elements between two elements.

It can be further understood that although operations are described in a particular order in the drawings in the embodiments of the present disclosure, this should not be construed as requiring that these operations be performed in the illustrated particular order or in a serial order, or that all the illustrated operations be performed to achieve desired results. Multi-task and parallel processing may be advantageous in certain circumstances.

Other embodiments of the present disclosure will readily occur to those skilled in the art after considering the specification and practice of the disclosure disclosed herein. The present application is intended to cover any modifications, uses, or adaptations of the present disclosure that follow the general principles of the present disclosure and include common general knowledge or customary techniques in the art not disclosed herein. The specification and embodiments are to be considered to be exemplary only, with the true scope and spirit of the present disclosure being indicated by the following claims.

It should be understood that the present disclosure is not limited to the precise configuration described above and shown in the drawings, and that various modifications and variations may be made without departing from its scope. The scope of the present disclosure is limited solely by the appended claims.

1. A torque control method for an all-wheel distributed vehicle, comprising:
response to a skidding state of a vehicle, acquiring adhesion coefficients of a reference wheel and other wheels;
on the basis of the adhesion coefficients of the other wheels, acquiring a target drive torque for preventing the skidding of the reference wheel;
in response to the reference wheel not skidding, acquiring a wheel linear speed of the reference wheel, and taking the wheel linear speed as a reference vehicle speed of the vehicle; and
adjusting drive torques of the other wheels on the basis of the reference vehicle speed.

2. The torque control method for an all-wheel distributed vehicle according to claim 1, wherein the on the basis of the adhesion coefficients of the other wheels, acquiring a target drive torque for preventing the skidding of the reference wheel comprises:
on the basis of the adhesion coefficients of the other wheels, acquiring a target adhesion rate of the reference wheel;
acquiring a wheel load of the reference wheel; and
on the basis of the target adhesion rate and the wheel load of the reference wheel, acquiring a target drive torque for preventing the skidding of the reference wheel.

3. The torque control method for an all-wheel distributed vehicle according to claim 2, wherein the target adhesion rate of the reference wheel is a difference between the minimum value of the adhesion coefficients of the other wheels and a calibration value.

4. The torque control method for an all-wheel distributed vehicle according to claim 2, wherein the target adhesion rate of the reference wheel is a difference between an adhesion coefficient of a wheel on the same side and a calibration value.

5. The torque control method for an all-wheel distributed vehicle according to claim 1, wherein the adjusting drive torques of the other wheels on the basis of the reference vehicle speed comprises:
on the basis of the reference vehicle speed, acquiring actual slip rates of the other wheels; and
in response to differences between the actual slip rates of the other wheels and a target slip rate, adjusting the drive torques of the other wheels, respectively.

6. A torque control system for an all-wheel distributed vehicle, comprising:
an adhesion coefficient acquisition module configured to, in response to a skidding state of a vehicle, acquire adhesion coefficients of a reference wheel and other wheels;
a drive torque acquisition module configured to, on the basis of the adhesion coefficients of the other wheels, acquire a target drive torque for preventing the skidding of the reference wheel;
a reference vehicle speed acquisition module configured to, in response to the reference wheel not skidding, acquire a wheel linear speed of the reference wheel, and taking the wheel linear speed as a reference vehicle speed of the vehicle; and
an adjustment module configured to adjust drive torques of the other wheels on the basis of the reference vehicle speed.

7. The torque control system for an all-wheel distributed vehicle according to claim 6, wherein the drive torque acquisition module further comprises:
a first acquisition module configured to, on the basis of the adhesion coefficients of the other wheels, acquire a target adhesion rate of the reference wheel;
a second acquisition module configured to acquire a wheel load of the reference wheel; and
a third acquisition module configured to, on the basis of the target adhesion rate and the wheel load of the reference wheel, acquire a target drive torque for preventing the skidding of the reference wheel.

8. The torque control system for an all-wheel distributed vehicle according to claim 7, wherein in the first acquisition module, the target adhesion rate of the reference wheel is a difference between the minimum value of the adhesion coefficients of the other wheels and a calibration value.

9. The torque control system for an all-wheel distributed vehicle according to claim 7, wherein in the first acquisition module, the target adhesion rate of the reference wheel is a difference between an adhesion coefficient of a wheel on the same side and a calibration value.

10. The torque control system for an all-wheel distributed vehicle according to claim 6, wherein the adjusting drive torques of the other wheels on the basis of the reference vehicle speed comprises:
a fourth acquisition module configured to, on the basis of the reference vehicle speed, acquire actual slip rates of the other wheels; and
a first adjustment module configured to, in response to the differences between the actual slip rates of the other wheels and a target slip rate, adjust the drive torques of the other wheels, respectively.

11. A torque control method for an all-wheel distributed vehicle, comprising:
acquiring, in response to a skidding state of a vehicle, acquiring adhesion coefficients of a reference wheel and other wheels;
acquiring, on the basis of the adhesion coefficients of the other wheels, a target drive torque for preventing the skidding of the reference wheel comprising acquiring a target adhesion rate of the reference wheel;
acquiring, in response to the reference wheel not skidding, a wheel linear speed of the reference wheel, and taking the wheel linear speed as a reference vehicle speed of the vehicle; and
adjusting drive torques of the other wheels on the basis of the reference vehicle speed.

12. The torque control method for an all-wheel distributed vehicle according to claim 11, further comprising:
acquiring a wheel load of the reference wheel.

13. The torque control method for an all-wheel distributed vehicle according to claim 12, further comprising:
on the basis of the target adhesion rate and the wheel load of the reference wheel, acquiring a target drive torque for preventing the skidding of the reference wheel.

14. The torque control method for an all-wheel distributed vehicle according to claim 12, wherein the wheel load of the reference wheel is acquired via at least one of longitudinal acceleration from a sensor, lateral acceleration from a sensor, road slope, or road inclination.

15. The torque control method for an all-wheel distributed vehicle according to claim 11, wherein the target adhesion rate of the reference wheel is a difference between the minimum value of the adhesion coefficients of the other wheels and a calibration value.

16. The torque control method for an all-wheel distributed vehicle according to claim 11, wherein the target adhesion rate of the reference wheel is a difference between an adhesion coefficient of a wheel on the same side and a calibration value.

17. The torque control method for an all-wheel distributed vehicle according to claim 11, wherein the adjusting drive torques of the other wheels on the basis of the reference vehicle speed comprises:
on the basis of the reference vehicle speed, acquiring actual slip rates of the other wheels.

18. The torque control method for an all-wheel distributed vehicle according to claim 16, further comprising:
in response to differences between the actual slip rates of the other wheels and a target slip rate, adjusting the drive torques of the other wheels, respectively.
